(19) United States
(12) Patent Application Publication
(10) Pub. No.: US 2023/0232262 A1
(43) Pub. Date: Jul. 20, 2023

(54) NTN-RELATED COMMUNICATION

(71) Applicant: LG ELECTRONICS INC., Seoul (KR)

(72) Inventors: Jinwoong PARK, Seoul (KR); Jinyup HWANG, Seoul (KR); Yoonoh YANG, Seoul (KR); Sangwook LEE, Seoul (KR); Suhwan LIM, Seoul (KR)

(21) Appl. No.: 18/099,435

(22) Filed: Jan. 20, 2023

Related U.S. Application Data
(63) Continuation of application No. PCT/KR2021/014571, filed on Oct. 19, 2021.

(30) Foreign Application Priority Data
Oct. 23, 2020 (KR) 10-2020-0138669

(51) Int. Cl. H04W 24/08

(52) U.S. Cl. CPC H04W 24/08

(57) ABSTRACT

Provided in one disclosure of the present specification is a method by which a UE performs NTN-related communication. The method may comprise the steps of: receiving, from a base station, NTN-related information; determining the measurement state of the UE from among a first measurement state, a second measurement state, and a third measurement state; and measuring, on the basis of the measurement state of the UE, the signal of a flying object or a satellite related to the NTN.

### CROSS-REFERENCE TO RELATED APPLICATIONS

This application is a Bypass Continuation filing of International Application No. PCT/KR2021/014571, filed on Oct. 19, 2021, which claims the benefit of KR patent Application No. 10-2020-0138669, filed on Oct. 23, 2020, the contents of which are all hereby incorporated by reference herein in their entirety.

### TECHNICAL FIELD

The present disclosure relates to mobile communication.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

Non-Terrestrial Network (NTN) based communication is being discussed in NR. The terminal may perform NTN-based communication with artificial satellites, air vehicles, and the like. Meanwhile, conventionally, a method for a terminal to effectively perform NTN-based communication has not been discussed. For example, a method for a terminal to perform measurements related to NTN-based communication and a method for supporting mobility (e.g., cell reselection, handover, etc.) of the UE have not been clearly discussed.

### SUMMARY

Accordingly, a disclosure of the present specification has been made in an effort to solve the aforementioned problem.

In order to solve the above problem, one disclosure of the present specification provides a method for a UE to perform NTN-related communication. The method comprising: receiving information related to the NTN from a base station; determining a measurement state of the UE from among a first measurement state, a second measurement state, or a third measurement state; and measuring a signal of a satellite or air vehicle related to NTN based on the measurement state of the UE.

In order to solve the above problems, one disclosure of the present specification provides a UE performing communication related to NTN. The UE includes at least one transceiver; at least one processor; and at least one memory that stores instructions and is operatively electrically connectable with the at least one processor. Operations performed based on the command being executed by the at least one processor may include: receiving information related to the NTN from a base station; determining a measurement state of the UE from among a first measurement state, a second measurement state, or a third measurement state; and measuring a signal of a satellite or air vehicle related to NTN based on the measurement state of the UE.

In order to solve the above problems, one disclosure of the present specification provides a device in mobile communication. The device includes at least one processor; and at least one memory that stores instructions and is operably electrically connectable with the at least one processor, wherein the instructions are executed based on execution by the at least one processor. Operations performed based on the command being executed by the at least one processor may include: receiving information related to the NTN from a base station; determining a measurement state of the UE from among a first measurement state, a second measurement state, or a third measurement state; and measuring a signal of a satellite or air vehicle related to NTN based on the measurement state of the UE.

In order to solve the above problems, one disclosure of the present specification provides a non-volatile (non-volatile) computer readable storage medium recording instructions. The instructions, when executed by one or more processors, cause the one or more processors to: receiving information related to the NTN from a base station; determining a measurement state of the UE from among a first measurement state, a second measurement state, or a third measurement state; and measuring a signal of a satellite or air vehicle related to NTN based on the measurement state of the UE.

According to the disclosure of the present specification, it is possible to solve the problems of the related art.

Effects that can be obtained through specific examples of the present specification are not limited to the effects listed above. For example, various technical effects that a person having ordinary skill in the related art can understand or derive from the present specification may exist. Accordingly, the specific effects of the present specification are not limited to those explicitly described herein, and may include various effects that can be understood or derived from the technical characteristics of the present specification.

### BRIEF DESCRIPTION OF THE DRAWINGS

FIG. 1 shows an example of a communication system to which implementation of the present disclosure is applied.

FIG. 2 shows an example of a wireless device to which implementation of the present disclosure is applied.

FIG. 3 shows an example of a wireless device to which implementation of the present disclosure is applied.

FIG. 4 shows an example of a radio frame structure of NR to which implementation of the present disclosure is applied.

FIG. 5 shows an example of a slot structure of an NR frame to which implementation of the present disclosure is applied.

FIG. 6 is an exemplary diagram illustrating an example of an SS block in NR.

FIG. 7 an exemplary diagram illustrating an example of beam sweeping in NR.

FIG. 8 illustrate a procedure of measurement and measurement report considering an SS burst.

FIG. 9 shows a first example of an NTN scenario.

FIG. 10 shows a second example of an NTN scenario.

FIG. 11 shows an example of a state of a terminal according to an embodiment of the disclosure of this specification.

FIG. 12 shows an example of a location of a UE according to an embodiment of the disclosure herein.

FIG. 13 shows an example of a state according to a location of a UE according to an embodiment of the disclosure of this specification.

FIG. 14 shows an example of an operation of a terminal according to an embodiment of the disclosure of this specification.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. Evolution of 3GPP LTE includes LTE-A (advanced), LTE-A Pro, and/or 5G NR (new radio).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

Although a user equipment (UE) is illustrated by way of example in the accompanying drawings, the illustrated UE may be referred to as a terminal, mobile equipment (ME), and the like. In addition, the UE may be a portable device such as a notebook computer, a mobile phone, a PDA, a smartphone, and a multimedia device or may be a non-portable device such as a PC or a vehicle-mounted device.

Hereinafter, a UE is used as an example of a wireless communication device (or a wireless device or wireless equipment) capable of wireless communication. An operation performed by a UE may be performed by a wireless communication device. A wireless communication device may also be referred to as a wireless device, wireless equipment, or the like. Hereinafter, AMF may mean an AMF node, SMF may mean an SMF node, and UPF may mean a UPF node.

A base station used below generally refers to a fixed station communicating with a wireless device and may also be referred as an evolved-NodeB (eNodeB), an evolved-NodeB (eNB), a base transceiver system (BTS), an access point, and a next generation NodeB (gNB).

### I. Techniques and Procedures Applicable to Present Disclosure

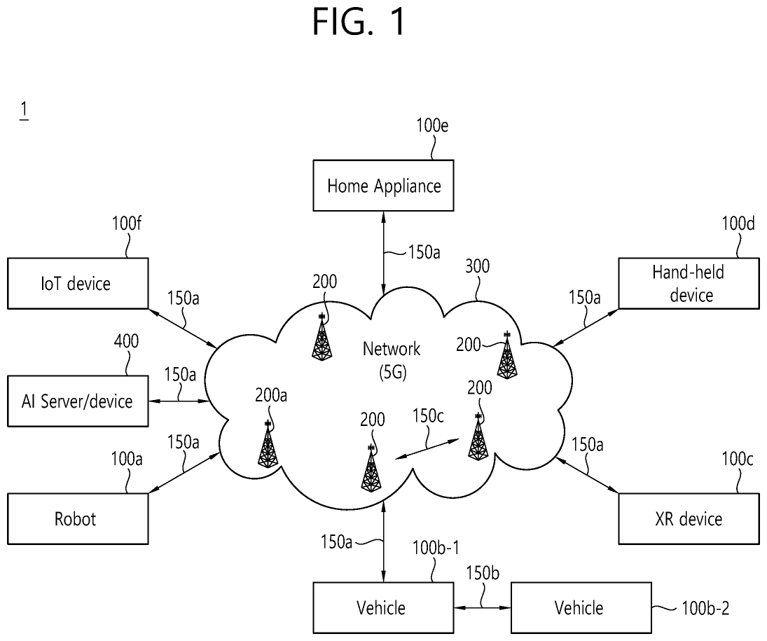

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an Internet of Things (IoT) device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

AI refers to the field of studying artificial intelligence or the methodology that can create it, and machine learning refers to the field of defining various problems addressed in the field of AI and the field of methodology to solve them. Machine learning is also defined as an algorithm that increases the performance of a task through steady experience on a task.

Robot means a machine that automatically processes or operates a given task by its own ability. In particular, robots with the ability to recognize the environment and make self-determination to perform actions can be called intelligent robots. Robots can be classified as industrial, medical, home, military, etc., depending on the purpose or area of use. The robot can perform a variety of physical operations, such as moving the robot joints with actuators or motors. The movable robot also includes wheels, brakes, propellers, etc., on the drive, allowing it to drive on the ground or fly in the air.

Autonomous driving means a technology that drives on its own, and autonomous vehicles mean vehicles that drive without user's control or with minimal user's control. For example, autonomous driving may include maintaining lanes in motion, automatically adjusting speed such as adaptive cruise control, automatic driving along a set route, and automatically setting a route when a destination is set. The vehicle covers vehicles equipped with internal combustion engines, hybrid vehicles equipped with internal combustion engines and electric motors, and electric vehicles equipped with electric motors, and may include trains, motorcycles, etc., as well as cars. Autonomous vehicles can be seen as robots with autonomous driving functions.

Extended reality is collectively referred to as VR, AR, and MR. VR technology provides objects and backgrounds of real world only through computer graphic (CG) images. AR technology provides a virtual CG image on top of a real object image. MR technology is a CG technology that combines and combines virtual objects into the real world. MR technology is similar to AR technology in that they show real and virtual objects together. However, there is a difference in that in AR technology, virtual objects are used as complementary forms to real objects, while in MR technology, virtual objects and real objects are used as equal personalities.

NR supports multiples numerologies (and/or multiple subcarrier spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., FR1 and FR2. The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter wave (mmW).

TABLE 1

| Frequency Range | | |
|---|---|---|
| designation | Corresponding frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | | |
|---|---|---|
| designation | Corresponding frequency range | Subcarrier Spacing |
| FR1 | 410 MHz-7125 MHz | 15, 30, 60 kHz |
| FR2 | 24250 MHz-52600 MHz | 60, 120, 240 kHz |

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

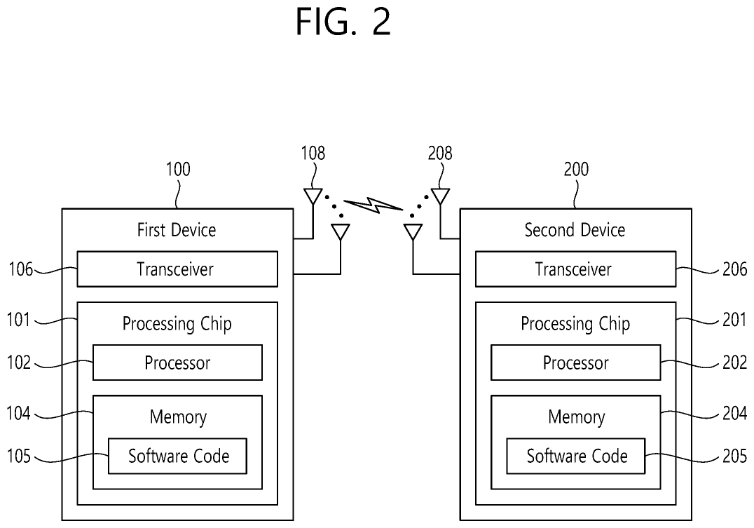

FIG. 2 Shows an Example of Wireless Devices to which Implementations of the Present Disclosure is Applied.

Referring to FIG. 2, a first wireless device 100 and a second wireless device 200 may transmit/receive radio signals to/from an external device through a variety of RATs (e.g., LTE and NR).

In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. It is exemplarily shown in FIG. 2 that the memory 104 is included in the processing chip 101. Additional and/or alternatively, the memory 104 may be placed outside of the processing chip 101.

The processor 102 may control the memory 104 and/or the transceiver 106 and may be configured to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with radio frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. It is exemplarily shown in FIG. 2 that the memory 204 is included in the processing chip 201. Additional and/or alternatively, the memory 204 may be placed outside of the processing chip 201.

The processor 202 may control the memory 204 and/or the transceiver 206 and may be configured to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

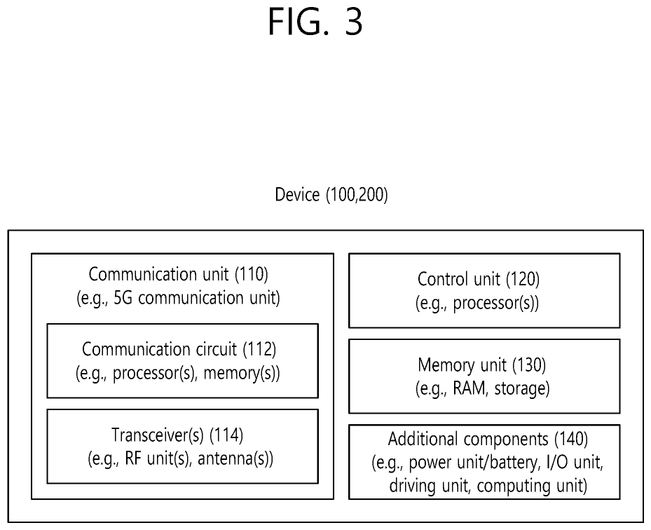

FIG. 3 Shows an Example of a Wireless Device to which Implementations of the Present Disclosure is Applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory unit 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory unit 130 may be configured by a RAM, a DRAM, a ROM, a flash memory, a volatile memory, a non-volatile memory, and/or a combination thereof.

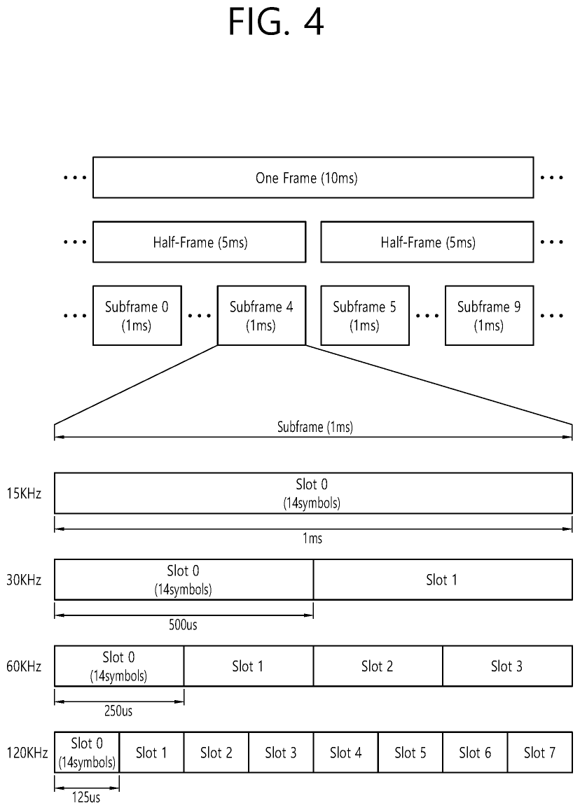

FIG. 4 Shows an Example of a Radio Frame Structure of NR to which Implementation of the Present Disclosure is Applied.

FIG. 4 shows a radio frame structure of NR according to an embodiment of the present disclosure. The embodiment of FIG. 4 may be combined with various embodiments of the present disclosure.

Referring to FIG. 4, a radio frame may be used in uplink and downlink transmission in NR. The radio frame has a length of 10 ms and may be defined as two 5 ms half-frames (HF). A half-frame may include 5 1 ms subframes (SF). A subframe may be divided into one or more slots, and the number of slots in a subframe may be determined according to a subcarrier spacing (SCS). Each slot may include 12 or 14 OFDM(A) symbols according to a cyclic prefix (CP).

When a normal CP is used, each slot may include 14 symbols. When an extended CP is used, each slot may include 12 symbols. Here, the symbol may include an OFDM symbol (or a CP-OFDM symbol), a single carrier-FDMA (SC-FDMA) symbol (or a discrete Fourier transform-spread-OFDM (DFT-s-OFDM) symbol).

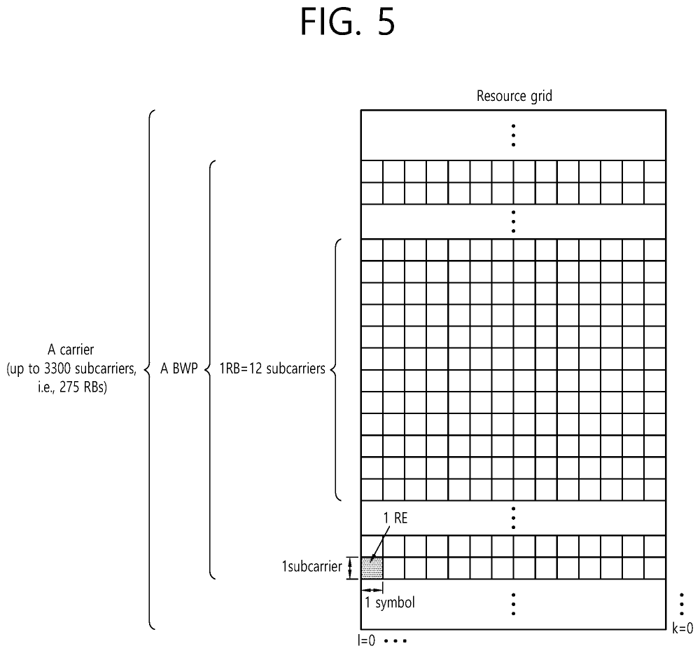

FIG. 5 Shows an Example of a Slot Structure of an NR Frame to which Implementation of the Present Disclosure is Applied.

FIG. 5 shows a slot structure of an NR frame according to an embodiment of the present disclosure. The embodiment of FIG. 5 may be combined with various embodiments of the present disclosure.

Referring to FIG. 5, a slot includes a plurality of symbols in the time domain. For example, one slot may include 14 symbols in the case of the normal CP, whereas one slot may include 12 symbols in the case of an extended CP. Alternatively, one slot may include 7 symbols in the case of a normal CP, whereas one slot may include 6 symbols in the case of an extended CP.

A carrier includes a plurality of subcarriers in the frequency domain. A resource block (RB) may be defined as a plurality of (e.g., 12) consecutive subcarriers in the frequency domain. A bandwidth part (BWP) may be defined as a plurality of consecutive (physical) resource blocks ((P)RB) in the frequency domain and may correspond to one numerology (e.g., SCS, CP length, etc.). A carrier may include a maximum of N (e.g., 5) BWPs. Data communication may be performed through an activated BWP. Each element may be referred to as a resource element (RE) in a resource grid, and one complex symbol may be mapped thereto.

A radio interface between UEs or a radio interface between a UE and a network may be configured as an L1 layer, an L2 layer, and an L3 layer. In various embodiments of the present disclosure, the L1 layer may mean a physical layer. For example, the L2 layer may mean at least one of a MAC layer, an RLC layer, a PDCP layer, and an SDAP layer. For example, the L3 layer may mean an RRC layer.

<SS Block in NR>

An SS block (Synchronization Signal Block: SSB) includes information necessary for a terminal to perform initial access in 5G NR, i.e., a Physical Broadcast Channel (PBCH) including a Master Information Block (MIB) and a Synchronization Signal (SS) (including PSS and SSS). SS block may mean SS/PBCH block.

In addition, a plurality of SSBs may be grouped to define an SS burst, and a plurality of SS bursts may be grouped to define an SS burst set. It is assumed that each SSB is beamformed in a specific direction, and several SSBs in an SS burst set are designed to support terminals in different directions.

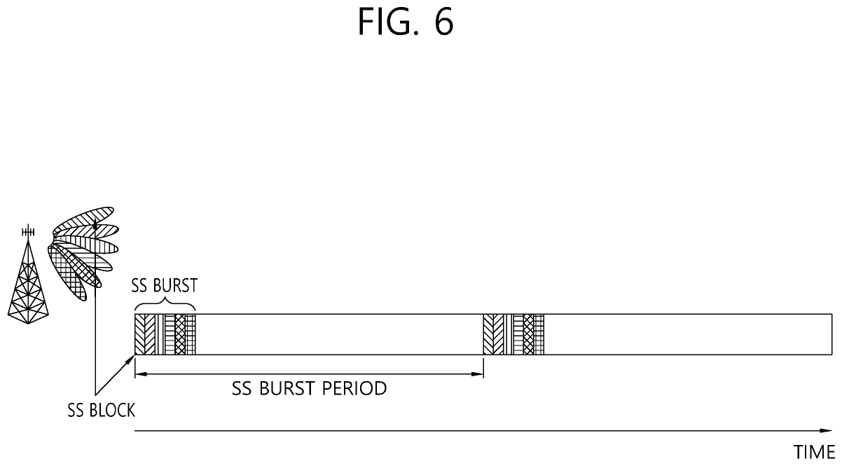

FIG. 6 is an Exemplary Diagram Illustrating an Example of an SS Block in NR.

Referring to FIG. 6, an SS burst is transmitted in every predetermined periodicity. Accordingly, a UE receives SS blocks, and performs cell detection and measurement.

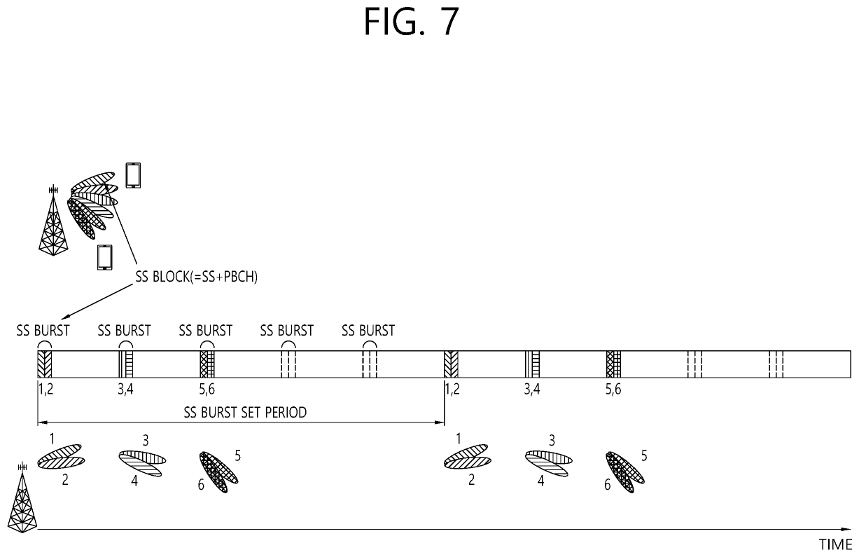

Meanwhile, in the 5G NR, beam sweeping is performed on an SS. A detailed description thereof will be provided with reference to FIG. 7.

FIG. 7 is an Exemplary Diagram Illustrating an Example of Beam Sweeping in the NR.

A base station transmits each SS block in an SS burst over time while performing beam sweeping. In this case, multiple SS blocks in an SS burst set are transmitted to support UEs existing in different directions. In FIG. 7, the SS burst set includes one to six SS blocks, and each SS burst includes two SS blocks.

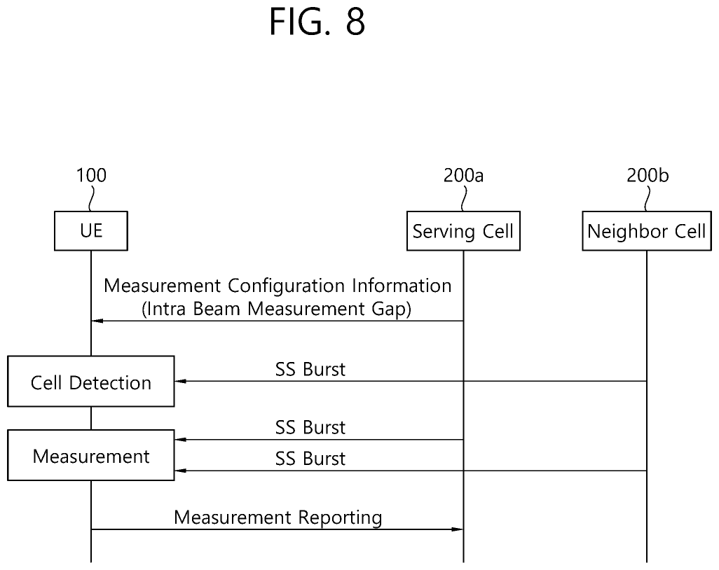

FIG. 8 Illustrates Measurement and a Measurement Report Procedure Considering an SS Burst.

As can be seen with reference to FIG. 8, a UE may receive measurement configuration information from a serving cell. The measurement configuration information may include information on a first measurement gap, e.g., an intra beam measurement gap. In addition, the measurement configuration information may include information on a second measurement gap, e.g., an intra RSRP measurement gap.

The UE may receive an SS burst from one or more neighbor cells to perform cell detection.

In addition, the UE may perform measurement based on the SS burst received from the one or more neighbor cells during a first measurement gap (e.g., an intra beam measurement gap) indicated by the information.

In addition, although not shown, the UE may perform RSRP measurement based on a reference signal (RS) from the one or more neighbor cells during the second measurement gap.

In addition, the UE may perform measurement reporting.

<Non-Terrestrial Network (NTN)>

In the following, an example overview of a non-terrestrial network (NTN) is described.

NTN may indicate a network or network segment using Radio Frequency (RF) resources mounted on a satellite (or an Unmanned Aerial System (UAS) platform).

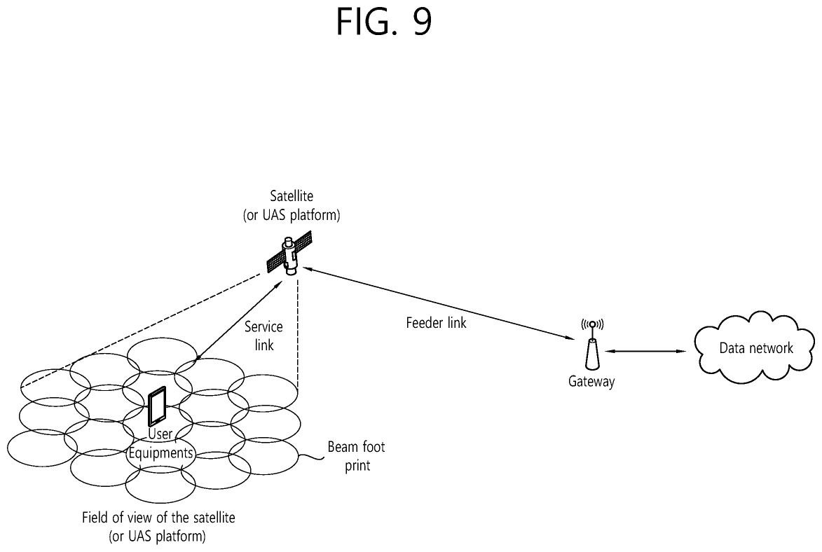

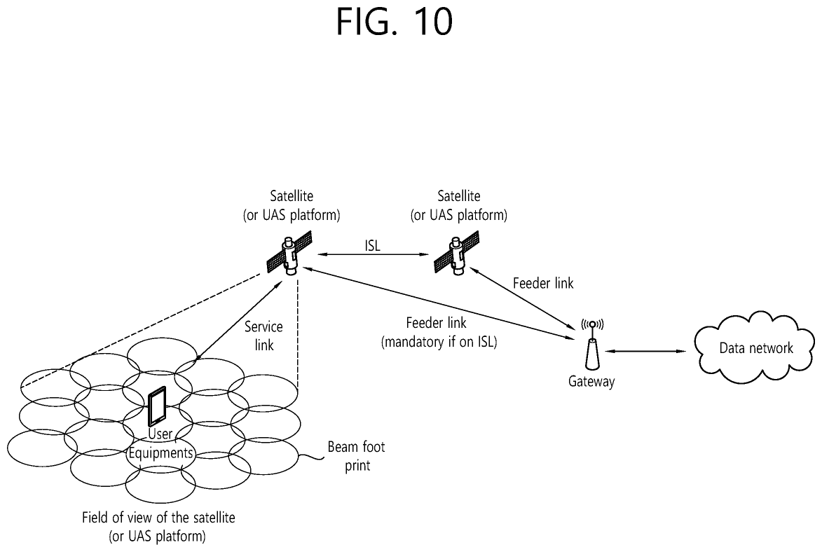

A typical scenario of the NTN providing access to the UE is as illustrated in FIG. 9 or FIG. 10 below.

The following drawings are made to explain a specific example of the present specification. Since the names of specific devices or names of specific signals/messages/fields described in the drawings are provided as examples, the technical features of the present specification are not limited to the specific names used in the drawings below.

FIG. 9 Shows a First Example of an NTN Scenario.

The example of FIG. 9 shows an example of an NTN typical scenario based on a transparent payload.

Referring to the example of FIG. 9, a satellite (or UAS platform) may generate a service link with a UE. A satellite (or UAS platform) can be connected to the gateway through a feeder link. Satellites can be connected to data networks through gateways. The beam footprint may mean an area in which a signal transmitted by a satellite can be received.

The following drawings are made to explain a specific example of the present specification. Since the names of specific devices or names of specific signals/messages/fields described in the drawings are provided as examples, the technical features of the present specification are not limited to the specific names used in the drawings below.

FIG. 10 Shows a Second Example of an NTN Scenario.

The example of FIG. 10 shows an example of an NTN typical scenario based on a regenerative payload.

Referring to the example of FIG. 10, a satellite (or UAS platform) may create a service link with a UE. A satellite (or UAS platform) connected to the UE can be connected to another satellite (or UAS platform) through Inter-satellite links (ISL). Other satellites (or UAS platforms) can be connected to the gateway via feeder links. A satellite can connect to a data network through a gateway with other satellites, based on the regenerated payload. If there is no ISL between a satellite and another satellite, a feeder link between the satellite and the gateway is required.

For reference, the above examples of FIG. 9 and FIG. 10 are merely examples of NTN scenarios, and NTN can be implemented based on various types of scenarios.

NTN can generally be characterized by the following elements:
One or several sat-gateways (satellite gateways) connecting NTN to the public data network:

i) Geostationary Earth Orbit (GEO) satellites may be fed by one or several satellite gateways deployed over satellite coverage (e.g., regional or even continental coverage). It can be assumed that a UE in a cell is served by only one sat-gateway.

ii) Non-GEO satellites may be continuously served by one or several satellite gateways at a time. The system can guarantee service and feeder link continuity between successive service satellite gateways with a time duration sufficient to proceed with mobility anchoring and handover.
Feeder link or radio link between sat-gateway and satellite (or UAS platform).
Service link or radio link between UE and satellite (or UAS platform).
Satellites (or UAS platforms) capable of implementing transparent or regenerative (with on board processing) payloads. A satellite (or UAS platform) may generally generate multiple beams over a designated service area depending on the field of view of the satellite (or UAS platform). The footprints of the beam may be generally elliptical. The field of view of a satellite (or UAS platform) may vary depending on the onboard antenna diagram and minimum elevation angle:

i) Transparent payload: may include radio frequency filtering, frequency conversion and amplification. Thus, the waveform signal repeated by the payload may not change;

ii) regenerative payload: may include radio frequency filtering, frequency conversion and amplification, demodulation/decoding, switching and/or routing, and coding/modulation. The regenerative payload may be substantially equivalent to loading all or part of the base station functionality (e.g., gNB) on a satellite (or UAS platform).
For constellation of satellites, may optionally include inter-satellite link (ISL). This may require a playback payload on the satellite. ISLs can operate at RF frequencies or wide bands.
The UE may be served by a satellite (or UAS platform) within the targeted service area.

Table 3 below shows a list of various types of satellites (or UAS platforms).

TABLE 3

| | | | Typical |
|---|---|---|---|
| | | | beam |
| | | | footprint |
| Platform | Altitude range | Orbit | size |
| Low-Earth Orbit | 300-1500 km | Circular around the | 100- |
| (LEO) satellite | | earth | 1000 km |
| Medium-Earth | 7000-25000 km | | 100- |
| Orbit (MEO) | | | 1000 km |
| satellite | | | |
| Geostationary | 35 786 km | notional station keeping | 200- |
| Earth Orbit | | position fixed in | 3500 km |
| (GEO) satellite | | terms of elevation/ | |
| | | azimuth with respect | |
| UAS platform | 8-50 km (20 km | to a given earth point | 5-200 |
| (including high | for HAPS) | | km |
| altitude pseudo | | | |
| satellite (HAPS)) | | | |
| High Elliptical | 400-50000 km | Elliptical around the | 200- |
| Orbit (HEO) | | earth | 3500 km |
| satellite | | | |

The examples in Table 3 show examples of the types of NTN platforms.

In general, GEO satellites and UAS may be used to provide continental, regional or local services. The constellation of LEO satellites and the constellation of MEO satellites can be used to provide services in both the northern and southern hemispheres. In some cases, the deployment of such satellites may provide global coverage including the polar regions. For global coverage, this may require proper orbit inclination, sufficient beams generated and ISLs.

### II. Disclosures of the Present Specification

Disclosures described later in this specification may be implemented in one or more combinations (e.g., a combination including at least one of the contents described below). Each of the drawings represents an embodiment of each disclosure, but the embodiments of the drawings may be implemented in combination with each other.

Description of the method proposed in the disclosure of this specification may be composed of a combination of one or more operations/configurations/steps described below. The following methods described below may be performed or used in combination or complementary.

Non-Terrestrial Network (NTN) based communication is being discussed in NR. The terminal may perform NTN-based communication with artificial satellites, air vehicles, and the like. Meanwhile, conventionally, a method for a terminal to effectively perform NTN-based communication has not been discussed. For example, a method for a UE to perform measurements related to NTN-based communication and a method for supporting UE mobility (e.g., cell reselection, handover, etc.) have not been clearly discussed.

For example, in communication between an existing TN base station and a terminal, mobility support (e.g., cell reselection, handover, etc.) of a terminal was possible even if only the signal strength of the base station was used. This is because, when the distance between the existing TN base station and the terminal is increased, attenuation of the signal received by the terminal is clearly observed. However, in NTN-based communication, attenuation of signals from satellites and/or vehicles is not clearly observed. Accordingly, there is a problem in that it is difficult to effectively support the measurement of signals of satellites and/or air vehicles and the mobility of the terminal with the method previously used by the terminal for NT-based communication.

The disclosure of this specification proposes content related to Non-Terrestrial Network (NTN) based communication of a 5G NR network. For example, the disclosure of the present specification proposes specifications required for measurement of satellite signals and/or vehicle signals in the NTN of a 5G NR network, and contents related to terminal and/or network operations.

In NTN of 5G networks, satellites or air vehicles can be used for various purposes. For example, in NTN of 5G networks, satellites or air vehicles can be utilized as base stations, relays, and repeaters.

In order for a terminal belonging to a TN to hand over to the NTN, the terminal may need to measure a signal of a satellite or an air vehicle. At this time, when a terminal belonging to a network, in which a sufficient TN infrastructure is built, periodically searches for signals of an NTN node (e.g., a satellite, an air vehicle, etc.), problems such as increased power consumption of the terminal may occur. In the disclosure of this specification, an operation of a terminal and/or a network for preventing an increase in power consumption of a terminal due to the terminal measuring a satellite signal and a vehicle signal in an NTN environment is proposed through various examples. In addition, in the disclosure of the present specification, through various examples, a terminal and/or network operation for triggering a timing at which the terminal measures the dominant signal and the vehicle signal is proposed. For example, in the disclosure of the present specification, an operation of a terminal and a network for preventing an increase in power consumption and triggering a measurement point due to measuring satellite and vehicle signals of a terminal in an NTN environment is proposed.

### 1. A First Example of the Present Disclosure

The first example of the disclosure of this specification proposes an example of a terminal state for power saving of an NTN supporting terminal with reference to various examples. Here, the NTN supporting terminal may mean a terminal supporting communication based on NTN.

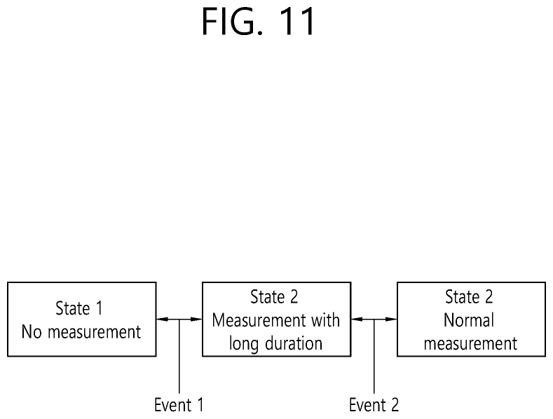

In the first example of the disclosure of the present specification, for example, a terminal supporting NTN may measure a signal of a satellite and/or a vehicle based on three states. The following example of FIG. 11 is an example diagrammatically illustrating these three states. States described below may also be referred to as measurement states.

The following drawings are made to explain a specific example of the present specification. Since the names of specific devices or names of specific signals/messages/fields described in the drawings are provided as examples, the technical features of the present specification are not limited to the specific names used in the drawings below.

FIG. 11 Shows an Example of a State of a Terminal According to an Embodiment of the Disclosure of this Specification.

Referring to the example of FIG. 11, three states of a terminal are shown. The illustrated three states are examples of states used by the terminal to measure a signal for communication based on NTN.

As in the example of FIG. 11, a terminal may have three states. The measurement described in the example of FIG. 11 may mean measurement of a satellite signal and/or a vehicle signal.

First, state 1 (state 1) may be a state in which the terminal does not measure the satellite signal and the vehicle signal at all. The terminal does not perform measurement of any satellite signal or vehicle signal until event 1 is triggered. Here, when the trigger condition of event 1 is satisfied, the state of the terminal in state 1 may be switched to state 2. In addition, when the reverse of the trigger condition of event 1 is established, the state of the terminal in state 2 may be switched to state 1.

Second, state 2 may mean a state in which the terminal measures a satellite signal and/or a vehicle signal with a long period. When the state of the terminal is state 2, state 2 may be maintained until event 2 is triggered. Alternatively, if the reverse of the trigger condition of event 1 is established, the state of the terminal may become state 1. The description of Events 1 and 2 is dealt with in detail in the second example of the disclosure of this specification.

Thirdly, state 3 may mean a state in which the terminal measures a satellite signal and/or a vehicle signal based on a general measurement period. When the state of the terminal is state 3, if the reverse of the trigger condition of event 2 is satisfied, the state of the terminal may become state 2. For example, a general measurement period may refer to a measurement period used by a terminal to measure a base station of a TN.

For example, the general cycle of state 3 described above may be a Discontinuous Reception (DRX) cycle. For example, when the state of the terminal is state 3, the terminal may measure the signal of the satellite and/or the signal of the vehicle once every time the DRX cycle elapses. For example, the long period of state 2 described above may be 60 seconds. Alternatively, the long cycle may mean an arbitrary time longer than the DRX cycle. For example, when the state of the terminal is state 2, the terminal may measure a satellite signal and/or a vehicle signal for a specific frequency band having a high priority once every 60 seconds.

### 2. The Second Example of the Disclosure of the Present Specification

In the second example of the disclosure of this specification, examples of events, conditions, and the like for the measurement state described above will be described with reference to various examples. For example, triggering of a measurement time point of a UE will be described.

When event 1 or event 2 that determines the state of the terminal occurs, the state of the terminal may change. Changing the state of the terminal will be referred to as triggering.

In the disclosure of this specification, a TN base station may provide measurement information related to NTN to a terminal. For example, a TN base station installed in a special area such as a mountainous and island area or an airport or port area may signal measurement information about a satellite and/or an air vehicle to a terminal.

The measurement information provided by the base station to the terminal may include information such as the example of Table 4 below.

TABLE 4

MeasurementforNTN
{
Whitelist satellite and airbone ID
Satellite and airbone orbit
Satellite and airbone SSB location
(optional) UE state indication
(optional) Coverage hole location information Lc
... ...
}

Referring to the example of Table 4, UE state indication and coverage hole location information L_{c} may be selectively provided.

In the example of Table 4, the whitelist satellite and airbone ID may indicate an ID of a satellite/vehicle determined to be nearby (e.g., near a base station or near a terminal). Satellite and airbone orbit may mean orbit and location information of a satellite or an air vehicle. The satellite and airbone SSB location may mean the SSB location of a satellite to be measured. UE state indication may mean a message used when the network directly changes the state of the UE. Coverage hole location information may mean a specific point (e.g., L_{c}) taught by the network. This specific point may be a point in an area where the current network does not service or a point in an area (i.e., a specific area covered by or believed to be covered by adjacent (neighboring) satellites) where service becomes unavailable. For reference, a specific point may also be referred to as a reference location.

That is, the measurement information signaled by the TN base station to the UE may include satellite and vehicle IDs, trajectories, flight information, and the location of reference signals used for measurement.

Additionally, the base station may recommend or indicate the state of the terminal described in the first example of the disclosure of this specification. For example, the base station may recommend or instruct changing the state of the terminal to state 1, state 2, or state 3. In addition, a base station installed on the high seas or near mountainous areas may include location information on the high seas or mountainous areas in measurement information.

Event 1 and event 2 described in the first example of the disclosure of this specification may be determined by at least one of three factors among i) Altitude information obtained by the UE from GNSS information, ii) Location information obtained by the UE from GNSS information, iii) Signal strength information of the UE's current serving cell and signal strength information of neighboring cells, etc. An example of these three elements is summarized as follows. For reference, various threshold values described below may be received by the terminal from the network, or the threshold values may be preset and stored in the terminal.

i) Altitude information: terminal's altitude z

ii) Location information: distance D between the location L of the terminal and L_{c} signaled from the base station

iii) Signal strength information of the current serving cell and signal strength information of neighboring cells: Signal strength Pₛ of the serving cell and signal strength Pₙ of the cell with the strongest signal among neighboring cells

When a specific event condition based on at least one of the above three information (e.g., information according to the examples of i) to iii)) is satisfied, the state of the terminal may be changed. For example, if any one of the above three pieces of information meets a condition of a specific event, the state of the terminal may be changed. An example of a condition of an event and an event may be as follows:

a. Measurement Trigger Based on an Altitude

Threshold values z1 and z2 related to altitude is proposed. The threshold values z1 and z2 related to altitude may be the threshold of Event 1 and the threshold of Event 2, respectively, and may be z1<z2. If the altitude z of the terminal satisfies z<z1, the terminal may maintain state 1. If the altitude z of the terminal is z1≤z<z2, the state of the terminal may be state 2, and if the altitude z of the terminal is z≥z2, the state of the terminal may be state 3.

Measurement triggering based on altitude can also be used in situations such as the following example. For example, this condition can be used in an environment in which the existing TN service cannot be used, such as when the altitude of the terminal changes (e.g., when the altitude of the terminal increases, such as when the terminal boards an object such as an airship). For another example, this condition may be utilized when the airship itself functions as an NTN terminal.

b. Measurement Triggering Based on Position

The terminal may receive information on a specific location (e.g., L_{c} in Table 4) from the base station. In this case, the terminal may calculate a distance difference D between L_{c} and the position L of the terminal. Position-related thresholds D₁ and D₂ are proposed. The thresholds D₁ and D₂ related to the position may be the threshold of Event 2 and the threshold of Event 1, respectively, and may be D₁<D₂. And, in a manner similar to the state change according to the altitude described in the example of a, the terminal can compare D and the threshold value D₂ of Event 1 and the threshold value D₁ of Event 2. The terminal may determine the state by comparing D with threshold values D₂ and D₁ of Event 1 and Event 2.

Location-based measurement triggers can also be used in situations such as the following examples. For example, this condition can be used when the NTN terminal moves to an area such as international waters or a desert.

c. Measurement Triggering Based on Signal Strength

Similar to the two trigger processes above (e.g. a and b), we define two different thresholds for event 2 and event 1. However, two different threshold values (Pₛ₁, Pₛ₂, Pₙ₁, Pₙ₂) can be set for Pₛ and Pₙ respectively. For reference, Pₛ₁<Pₛ₂ and Pₙ₁<Pₙ₂ may be satisfied. If Pₛ≥Pₛ₂ and Pₙ≥Pₙ₂ are satisfied, the state of the terminal may be state 1. Similarly, if (Pₛ₁≤Pₛ<Pₛ₂ & Pₙ₁≤Pₙ<Pₙ₂), the state of the UE may be state 2. If (Pₛ<Pₛ₁ & Pₙ<Pₙ₁), the state of the terminal may be state 3. As another example, P_{c} may be defined to be determined as the minimum value of Pₛ and Pₙ. Two different threshold values (P_{c1}, P_{c2}) can be set for P_{c}. When P_{c1} and P_{c2} are used, P_{c1} and P_{c2} may be the threshold of Event 2 and the threshold of Event 1, respectively, and P_{c1}<P_{c2}. If Pc satisfies P_{c}≥P_{c2}, the UE can maintain state 1. If P_{c} is P_{c1}≤Pₛ<P_{c2}, the state of the terminal can be state 2, and if P_{c} is P_{c}<P_{c1}, the state of the terminal can be state 3.

Measurement trigger by signal strength may be used in the following example. For example, this condition can be used when an NTN terminal moves to an area such as international waters or a desert, or when it moves out of coverage of an existing TN network.

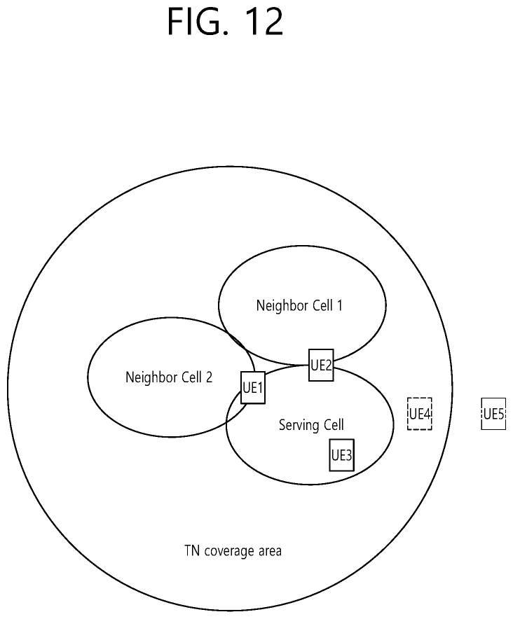

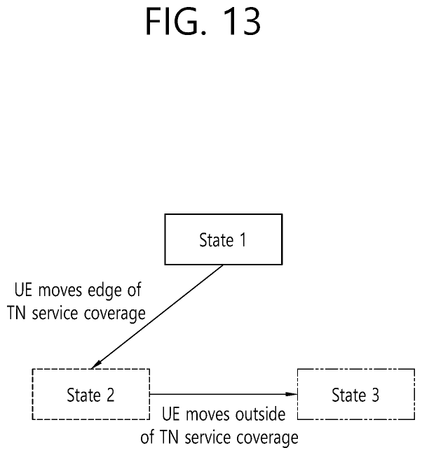

For reference, an example of the location of the UE and state change according to c may be shown as examples of FIG. 12 and FIG. 13 below.

The following drawings are made to explain a specific example of the present specification. Since the names of specific devices or names of specific signals/messages/fields described in the drawings are provided as examples, the technical features of the present specification are not limited to the specific names used in the drawings below.

FIG. 12 Shows an Example of a Location of a UE According to an Embodiment of the Disclosure Herein.

In the example of FIG. 12, the coverage of the serving cell, the coverage of the neighbor cell 1, and the coverage of the neighbor cell 2 are shown. And, the TN coverage area covered by TN base stations is shown.

In the example of FIG. 12, UEs 1 to 3 may be UEs whose signal strength of a serving cell or a signal strength of a neighboring cell is sufficiently guaranteed. Since the signal strength of the serving cell or the signal strength of the neighboring cell is sufficiently guaranteed, UE 1 to UE 3 may not need to measure signals for satellites or air vehicles. For example, the state of UE 1 to UE 3 may be State 1.

UE 4 may be a UE located at an edge of a TN radius (e.g., a TN coverage area). For UE 4, since the signals of both the serving cell and the neighbor cell are weakened, UE 4 may need to start measuring signals for satellites or vehicles at long intervals. For example, the state of UE 4 may be State 2.

UE 5 may be out of an area where TN service is available. The state of UE 5 may be state 3, and UE 5 may need to perform general signal measurement for a satellite or an air vehicle.

The following drawings are made to explain a specific example of the present specification. Since the names of specific devices or names of specific signals/messages/fields described in the drawings are provided as examples, the technical features of the present specification are not limited to the specific names used in the drawings below.

FIG. 13 Shows an Example of a State According to a Location of a UE According to an Embodiment of the Disclosure of this Specification.

Referring to FIG. 13, State 1 may be a state when the location of a UE is the location of UE 1 to UE 3 in FIG. 12.

When the UE located at the location of UE 1 to UE 3 moves to the edge of TN service coverage, the state of the UE may be State 2. For example, if UEs 1 to 3 move to the location of UE 4, the state of the UE may be State 2.

If the UE located at the location of UE 4 moves out of TN service coverage, the UE's state may become State 3. For example, if UE 4 moves to the location of UE 5, the state of the UE may be State 3.

The description of the states according to a to c described above and the conditions for each state can be summarized as shown in Table 5 below.

TABLE 5

| | State 1 | State 2 | State 3 |
|---|---|---|---|
| Altitude z | z < z₁ | z₁ ≤ z < z₂ | z ≥ z₂ |
| Distance D | D ≥ D₂ | D₁ ≤ D < D₂ | D < D₁ |
| based on | | | |
| location L | | | |
| signal | (Pₛ ≥ Pₛ₂ and Pₙ ≥ | Pₛ₁ ≤ Pₛ < Pₛ₂ & | (Pₛ < Pₛ₁ and Pₙ < Pₙ₁) |
| strength | Pₙ₂) or (Pₛ ≥ Pₛ₂ | Pₙ₁ ≤ Pₙ < Pₙ₂ | or (Pₛ < Pₛ₁ or |
| | or Pₙ ≥ Pₙ₂) | | Pₙ < Pₙ₁) |

According to the example of Table 5, if the condition related to the altitude z is satisfied, the state of the terminal may be one of State 1 to State 3. If the condition related to the distance D is satisfied, the state of the terminal may be one of State 1 to State 3. When a condition related to signal strength is satisfied, the state of the terminal may be one of State 1 to State 3.

In the example of Table 5, one or more conditions related to altitude z, distance D, or signal strength may be used in combination. For example, when two conditions, altitude z and distance D, are used in combination, if z<z1 is satisfied and D≥D₂ is satisfied, the state of the terminal may be State 1. For another example, all three conditions in the example of Table 5 may be used in combination. In this case, if z<z1 is satisfied, D≥D₂ is satisfied, and Ps≥Pₛ₂ or Pₙ≥Pₙ₂ is satisfied, the state of the UE may be State 1.

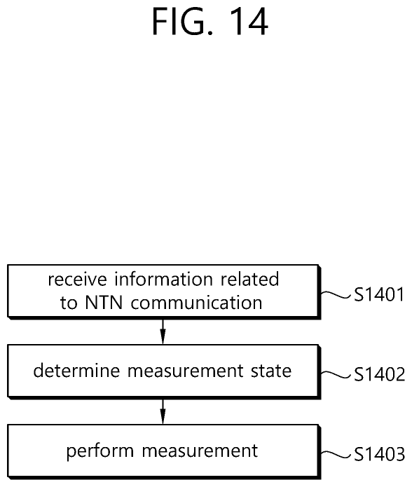

Hereinafter, with reference to FIG. 14, an example of an operation of a terminal according to the disclosure of the present specification will be described. The operation of the terminal described below may include the contents described through various examples above.

The following drawings are made to explain a specific example of the present specification. Since the names of specific devices or names of specific signals/messages/fields described in the drawings are provided as examples, the technical features of the present specification are not limited to the specific names used in the drawings below.

FIG. 14 Shows an Example of an Operation of a Terminal According to an Embodiment of the Disclosure of this Specification.

FIG. 14 shows an example of an operation of a terminal according to the disclosure of the present specification. The content shown in FIG. 14 is only an example, and the scope of the disclosure of this specification is not limited by FIG. 14.

The terminal may perform operations according to various examples (e.g., the first to second examples of the disclosure of the present specification, etc.) previously described in the disclosure of this specification.

For reference, in the example of FIG. 14, steps S1401, S1402, and S1403 are shown to be sequentially performed. However, this is just an example. The order in which steps S1401, S1402, and S1403 are performed is not limited by the order shown in FIG. For example, steps S1401, S1402, and S1403 may be performed simultaneously. For example, step S1402 and/or step S1403 may not be performed.

In step S1401, the terminal may receive information related to NTN communication from a network (e.g., a TN base station). Here, information related to NTN communication may be measurement information related to NTN described in the example of Table 4. For example, a terminal in a specific network may receive information (e.g., specific location L_{c}, orbit information, location of ssb, ID in the example of Table 4) of neighboring satellites (and/or air vehicles) from the network.

The terminal may calculate distance, signal strength, altitude, etc. using information received from the network. For example, the terminal may calculate the distance D between the location L of the terminal and L_{c} signaled from the base station. The terminal may calculate the altitude z of the terminal. The terminal may calculate the signal strength Pₛ of the serving cell and the signal strength Pₙ of the cell having the strongest signal among neighboring cells.

In step S1402, the terminal may determine a state related to measurement. For reference, the terminal may directly determine a state related to measurement, or the terminal may determine a state related to measurement according to a network instruction (or command, etc.).

For example, when the terminal directly determines the state, the terminal may determine the state in the same manner as in the example of Table 5, based on the altitude, the distance to L_{c}, the signal strength of the satellite, the signal strength Ps of the serving cell, and the signal strength Pₙ of the cell with the strongest signal among neighboring cells. At this time, the terminal may determine the state by considering only one condition, or may determine the state by considering a plurality of conditions in combination.

When the terminal determines the state by instructions (or commands, etc.) of the network, the terminal may report the altitude, the distance to L_{c}, the signal strength of the satellite, the signal strength Pₛ of the serving cell, and the signal strength Pₙ of the cell having the strongest signal among neighboring cells to the network. And, the network may indicate the state of the terminal based on the information reported and received from the terminal. For example, when the network indicates the state to the UE, the network may transmit “UE state indication” in the example of Table 4 to the UE.

In step S1403, the terminal may perform measurement. For example, the terminal may not perform measurement of a signal of a target satellite or may perform measurement based on a state related to measurement. For example, when the state of the terminal is state 1, the terminal may not periodically measure the signal of the target satellite. When the state of the terminal is state 2, the terminal can measure the signal of the target satellite at a long period. When the state of the terminal is state 3, the terminal may measure the signal of the target satellite at a regular cycle.

When the terminal measures the signal of the target satellite, if the signal strength of the satellite satisfies a specific condition (e.g., if the strength of the satellite signal is greater than a threshold value), the terminal may perform handover to a satellite or perform a cell reselection operation for a satellite. For example, if the distance between the terminal and L_{c}, the signal strength of the satellite, and the altitude meet specific conditions, the terminal may perform a handover operation or a cell reselection operation for the satellite.

For example, the terminal can know that it is located in the beam radius or center of the satellite through the distance to L_{c}. For example, if it is confirmed that the terminal is at the beam center of the satellite, the terminal may perform an HO operation or a cell reselection operation to the corresponding satellite.

As another example, in the case of altitude z, if a terminal installed on an airplane or a terminal boarding an airplane becomes higher than a specific altitude z₂ (e.g. 1000 m), the terminal may determine that it cannot perform handover to the ground base station. In addition, the terminal may perform a measurement for a HO operation to a satellite or a cell reselection operation, or may attempt an HO operation or a cell reselection operation.

For reference, various examples of the disclosure of this specification assume and describe that a terminal in TN performs an operation related to mobility from a base station of TN to a satellite/air vehicle. However, this is only an example, and various examples of the disclosure of this specification may be applied to any case in which a mobility target of a terminal is a satellite. For example, various examples of the disclosure of this specification are also applicable to a case in which an operation related to mobility to another satellite is performed in a state in which a serving cell of a terminal is a satellite.

According to the description in the disclosure of this specification with reference to various examples, a terminal can effectively and efficiently perform NTN-based communication. In addition, according to the description in the disclosure of this specification with reference to various examples, a method for a UE to perform measurement related to NTN-based communication and a method for supporting mobility of a UE can be clearly defined. According to the description in the disclosure of this specification with reference to various examples, in NTN-based communication, a terminal can effectively support measurement of a signal of a satellite and/or an air vehicle, and can effectively support mobility of the terminal.

For reference, the operation of the UE described in the present disclosure may be implemented by the devices of FIGS. 1 to 3 described above. For example, a terminal (e.g., UE) may be the first device 100 or the second device 200 of FIG. 1. For example, the operation of a terminal (e.g., UE) described in the present disclosure may be processed by one or more processors 102 or 202. The operation of the terminal described in the present disclosure may be stored in one or more memories 104 or 204 in the form of an instruction/program (e.g., instruction and executable code) executable by the one or more processors 102 or 202. The one or more processors 102 or 202 may control the one or more memories 104 or 204 and one or more transceivers 105 or 206 and execute instructions/programs stored in the one or more memories 104 or 204 to perform the operation of a terminal (e.g., UE) described in the present disclosure.

In addition, instructions for performing the operation of a terminal (e.g., UE) described in the present disclosure may be stored in a non-volatile computer-readable storage medium. The storage medium may be included in the one or more memories 104 or 204. In addition, the instructions recorded in the storage medium may be executed by the one or more processors 102 or 202 to perform the operation of a terminal (e.g., UE) described in the present disclosure.

For reference, the operations of a base station (e.g., NG-RAN, gNB, gNB (NB-IoT), gNB (NR) eNB, RAN, etc.) described in the present disclosure may be implemented by the devices of FIGS. 1 to 3 which will be described below. For example, the base station (e.g., NG-RAN, gNB, gNB (NB-IoT), gNB (NR) eNB, RAN, etc.) may be the first device 100a or the second device 100b of FIG. 1. For example, the operation of the base station (e.g., NG-RAN, gNB, gNB (NB-IoT), gNB (NR) eNB, RAN, etc.) described in the present disclosure may be processed by one or more processors 102 or 202. The operation of the terminal described in the present disclosure may be stored in one or more memories 104 or 204 in the form of an instruction/program (e.g., instruction and executable code) executable by the one or more processors 102 or 202. The one or more processors 102 or 202 may control the one or more memories 104 or 204 and one or more transceivers 106 or 206 and execute instructions/programs stored in the one or more memories 104 or 204 to perform the operation of the base station (e.g., NG-RAN, gNB, gNB (NB-IoT), gNB (NR) eNB, RAN, etc.) described in the present disclosure.

In addition, the instructions for performing the operation of the base station (e.g., NG-RAN, gNB, gNB (NB-IoT), gNB (NR) eNB, RAN, etc.) described in the present disclosure may be stored in a non-volatile (or non-transitory) computer-readable storage medium. The storage medium may be included in the one or more memories 104 or 204. In addition, the instructions recorded in the storage medium may be executed by the one or more processors 102 or 202 to perform the operation of the base station (e.g., NG-RAN, gNB, gNB (NB-IoT), gNB (NR) eNB), RAN, etc.) described in the present disclosure.

Although preferred embodiments have been described above, the present disclosure is not limited to such specific embodiments and thus can be modified, changed, or improved in various manners within the spirt of the present disclosure and the scope of the claims.

Although methods are described as a series of steps or blocks based on a flowchart in the exemplary system described above, they are not limited to the order of the described steps, and some steps may occur in a different order or simultaneously with other steps as described above. In addition, those skilled in the art will understand that the steps shown in the flowchart are not exclusive, and that other steps may be included or that one or more steps of a flowchart may be deleted without affecting the scope of rights.

The claims described herein may be combined in various ways. For example, the technical features of the method claims of the present disclosure may be combined and implemented as an apparatus, and the technical features of the apparatus claims of the present disclosure may be combined and implemented as a method. In addition, the technical features of the method claims of the present disclosure and the technical features of the apparatus claims may be combined and implemented as an apparatus, and the technical features of the method claims of the present disclosure and the technical features of the apparatus claims may be combined and implemented as a method.

1. A method for performing communication related to Non-Terrestrial Network (NTN), the method performed by a User Equipment (UE) and comprising:
receiving information related to the NTN from a base station,
wherein the information related to the NTN includes reference location information; and
determining whether to perform measurement, based on a distance between the reference location and a location of the UE,
wherein whether to perform the measurement is determined, based on the distance between the reference location and a location of the UE and threshold value.

2. (canceled)

3. The method of claim 1,
wherein the measurement is determined to be not performed, when the distance between the reference position and the position of the UE is less than the threshold value, and
wherein the measurement is determined to be performed, when the distance between the reference position and the position of the UE is greater than or equal to or larger than the threshold value.

4. The method of claim 1, further comprising:
performing a handover procedure or a cell reselection procedure, when the measured value based on the measurement is equal to or greater than the threshold value.

5. The method of claim 1,
wherein whether to perform the measurement is determined, based on at least one of i) the distance between the reference location and the location of the UE, ii) the altitude of the UE, or iii) the signal strength of the first neighboring cell having the strongest signal among at least one neighboring cell and the signal strength of the serving cell.

6. The method of claim 5,
wherein whether to perform the measurement is determined based on the altitude of the UE, a first altitude threshold value, and a second altitude threshold value.

7. (canceled)

8. The method of claim 5,
wherein whether to perform the measurement is, based on the signal strength of the serving cell and the signal strength of the first neighboring cell, a first threshold and a second threshold related to the signal strength of the serving cell, and a third threshold and a fourth threshold related to the signal strength of the first neighboring cell.

9. (canceled)

10. A User Equipment (UE) performing communication related to a Non-Terrestrial Network (NTN), the UE comprising:
at least one transceiver;
at least one processor; and
at least one memory that stores instructions and is operably electrically connectable with the at least one processor,
wherein operations performed based on the instructions being executed by the at least one processor include:
receiving information related to the NTN from a base station,
wherein the information related to the NTN includes reference location information; and
determining whether to perform measurement, based on a distance between the reference location and a location of the UE,
wherein whether to perform the measurement is determined, based on the distance between the reference location and a location of the UE and threshold value.

11. The UE of claim 10,
wherein the UE is an autonomous driving device that communicates with at least one of a mobile terminal, a network, and an autonomous vehicle other than the UE.

12. An apparatus in mobile communication, the apparatus comprising:
at least one processor; and
at least one memory that stores instructions and is operably electrically connectable with the at least one processor;
wherein operations performed based on the instructions being executed by the at least one processor include:
receiving information related to the NTN from a base station,
wherein the information related to the NTN includes reference location information; and
determining whether to perform measurement, based on a distance between the reference location and a location of the apparatus,
wherein whether to perform the measurement is determined, based on the distance between the reference location and a location of the apparatus and threshold value.

13. (canceled)
